(19) United States
(12) Patent Application Publication
(10) Pub. No.: US 2025/0280957 A1
(43) Pub. Date: Sep. 11, 2025

(54) RESIN FOAM AND SEAT

(71) Applicant: MAZDA MOTOR CORPORATION, Hiroshima (JP)

(72) Inventors: Daiji KATSURA, Etajima-shi (JP); Hiroyuki ITO, Aki-gun (JP)

(73) Assignee: MAZDA MOTOR CORPORATION, Hiroshima (JP)

(21) Appl. No.: 19/069,905

(22) Filed: Mar. 4, 2025

(30) Foreign Application Priority Data
Mar. 5, 2024 (JP) 2024-033105

(51) Int. Cl. A47C 7/18; C08G 18/32; C08G 18/48; C08G 18/66

(52) U.S. Cl. CPC A47C 7/18; C08G 18/3281; C08G 18/4829; C08G 18/6688; C08G 2110/0008; C08G 2110/0083

(57) ABSTRACT

A range of radii from a bubble radius of 0 mm to a maximum bubble radius is divided into 20 radius sections r₁ to r₂₀. Bubble volume rates are calculated by dividing a product of the number of bubbles having a radius r and a volume of the bubbles having the radius r by a volume of all the bubbles, and the bubble volume rates are integrated for each radius section rₙ. Integrated values thus obtained are plotted on the respective radius sections rₙ, thereby obtaining a scatter diagram. A first approximate straight line obtained from plots of a first bubble group in the scatter diagram and a second approximate straight line obtained from plots of a second bubble group have different slopes. A sum of bubble volume rates of the bubbles forming the second bubble group ranges from 10% to 80% of a whole bubble volume rate.

### CROSS-REFERENCE TO RELATED APPLICATION

This application claims priority to Japanese Patent Application No. 2024-033105 filed on Mar. 5, 2024, the entire disclosure of which is incorporated by reference herein.

### BACKGROUND

The present disclosure relates to a resin foam and a seat.

There has been a flexible foam as a typical resin foam with excellent cushioning properties. Such a resin foam is used as a cushion material for furniture, such as a sofa and a bed, or for a seat of a passenger car, for example. The cushion material plays an important role in appealing to the five senses of a person and giving comfort to the person by touch sensations, such as sitting comfort, sleeping comfort, and touch comfort.

The touch sensations of the resin foam are evaluated by physical indices indicating a sense of touch, a sense of support, and a sense of push-back when the resin foam is compressed. The sense of touch is, for example, a touch sensation at an initial stage where a load starts being applied to the resin foam: softness is required. The sense of support is, for example, a touch sensation when the resin foam is compressed by a load and unable to deform any more, that is, the state of the load reaching the bottom: a firm elastic force capable of supporting the load is required.

In order to obtain a good touch sensation, resin foams have been produced by various methods. For example, the methods include changing the composition of resin to obtain a resin foam with a lower elasticity modulus, and changing the molding conditions to have larger sizes of bubbles. Japanese Unexamined Patent Publication No. 2023-008067 (Patent Document 1) discloses a flexible polyurethane foam with bubbles whose presence ratio is controlled to be 5.0 or more, which is obtained by dividing the arithmetic average of the diameters of cells at the integrated values of 90% to 100% in a cumulative distribution, by the arithmetic average of the diameters of cells at the integrated values of 0% to 10%.

### SUMMARY

It is possible to reduce the elasticity modulus of the resin foam and obtain a soft touch sensation by changing the resin type or composition. Such techniques can improve the sense of touch, but the stroke until the load reaches the bottom is short, failing to provide a good sense of support. Increasing the presence ratio of large bubbles can lengthen the stroke, but thin bubble walls formed between the bubbles result in a decrease in function of the walls as columns supporting a load, failing to provide a good sense of support. The porosity may be reduced to improve the sense of support, but a problem arises that the weight increases. Patent Document 1 focuses on increasing the warpage of the flexible polyurethane foam in a high load area, which improves the sense of support but does not improve the sense of touch.

To address this, it is an object of the present disclosure to provide a resin foam and a seat that can achieve both a good sense of touch at the initial stage where a load starts being applied and a good sense of support in the state of the load reaching the bottom.

In order to achieve the above object, an aspect of a resin foam according to the present disclosure is directed to
a resin foam including: a first bubble group of bubbles having a radius r less than a predetermined value; and a second bubble group of bubbles having a radius r of the predetermined value or more,
by using the number of bubbles included in the resin foam and a bubble radius r which are obtained by a structural analysis,
a range of radii from a bubble radius of 0 mm to a maximum bubble radius of the bubbles included in the resin foam being divided into 20 radius sections r₁ to r₂₀,
bubble volume rates being calculated by dividing a product of the number of bubbles having a radius r included in the range greater than a radius section rₙ₋₁ and less than or equal to a radius section rₙ, where n is an integer of 1 to 20, and a volume of the bubbles having the radius r by a volume of all the bubbles; the bubble volume rates being integrated for each radius section rₙ,
integrated values thus obtained being plotted on the respective radius sections, thereby obtaining a scatter diagram,
two approximate straight lines being obtained from the scatter diagram,
the two approximate straight lines including: a first approximate straight line obtained from plots of the first bubble group; and a second approximate straight line obtained from plots of the second bubble group, the first approximate straight line and the second approximate straight line having different slopes,
a sum of bubble volume rates of the bubbles forming the second bubble group ranging from 10% to 80% of a whole bubble volume rate.

According to the configuration described above, the resin foam includes bubbles that can be divided into at least two groups, namely, the first bubble group of small bubbles and the second bubble group of large bubbles. For example, if a histogram is created by showing the volume rate on the vertical axis and the radius on the horizontal axis, the histogram will be a multimodal histogram. The volume rates of the first bubble group and the volume rates of the second bubble group are distributed apart from each other, which is a structure in which a bubble wall between large bubbles is formed by the group of small bubbles. According to this structure, a large number of skeletons are formed by the bubble walls between the small bubbles. A load is absorbed by the skeletons of the group of small bubbles, which can improve the sense of touch. According to this structure, it is also possible to keep a sufficient sense of support. Thus, both the good sense of touch and the good sense of support can be achieved by the structure described above.

In one embodiment, the predetermined value ranges from 0.5 mm to 1.2 mm, that is, from 25% to 75%, preferably from 30% to 70%, and more preferably from 40% to 65% of the maximum bubble radius.

According to this configuration, a histogram where the vertical axis represents the bubble volume rate and the horizontal axis represents the bubble radius section has two peaks of distribution showing the first bubble group and the second bubble group, with a boundary at a bubble size from 0.5 mm to 1.2 mm, that is, from 25% to 75% of the maximum bubble radius. It is easy to achieve both the good sense of touch and the good sense of support in the resin foam having this configuration.

In one embodiment, the maximum bubble radius in a structural analysis area of the above resin foam is less than 2000 μm.

According to this configuration, bubbles in a size of 2000 μm or more are excluded as being considered to be voids caused by molding defects. It is thus possible to evaluate the structure of the resin foam without taking influence of such bubbles into account.

In one embodiment, the resin foam has a communication hole provided in a bubble wall between adjacent bubbles to cause the bubbles to communicate with each other.

According to this configuration, it is possible to improve sound absorbability. The resin foam having such a configuration is well applicable to a cushion material of a seat of a passenger car, for example.

In one embodiment, the resin foam is made of a resin composition containing a cross-linkable polymer.

According to this configuration, a resin foam capable of achieving both the good sense of touch and the good sense of support is easily obtainable.

In one embodiment, the cross-linkable polymer of the above resin foam has a urethane bond.

In one embodiment, the resin foam is a flexible polyurethane foam.

In one embodiment, the resin foam has a porosity of 90% or more.

According to this configuration, the resin foam is suitable as a cushion material for a seat of a passenger car, for example.

An aspect of a seat disclosed herein uses the resin foam described above as a cushion material.

A seat having this configuration employs the resin foam achieving both the good sense of touch and the good sense of support as the cushion material. If the seat is applied as a seat of a passenger car, for example, there are a portion where a relatively large load is applied by the buttocks, and a portion where a relatively small load is applied by the thighs. The touch sensations are good at both the portions; it is thus possible to provide comfortable seating.

As described above, the present disclosure provides a resin foam and a seat that can achieve both a good sense of touch at the initial stage where a load starts being applied and a good sense of support in the state of the load reaching the bottom.

### BRIEF DESCRIPTION OF THE DRAWINGS

FIG. 1 is a scatter diagram showing the radii of bubbles included in a resin foam of Example 1 and integrated values of the bubble volume rates.

FIG. 2 is a scatter diagram showing the radii of bubbles included in a resin foam of Example 2 and integrated values of the bubble volume rates.

FIG. 3 is a scatter diagram showing the radii of bubbles included in a resin foam of Example 3 and integrated values of the bubble volume rates.

FIG. 4 is a scatter diagram showing the radii of bubbles included in a resin foam of Example 4 and integrated values of the bubble volume rates.

FIG. 5 is a scatter diagram showing the radii of bubbles included in a resin foam of Comparative Example 1 and integrated values of the bubble volume rates.

FIG. 6 is a scatter diagram showing the radii of bubbles included in a resin foam of Comparative Example 2 and integrated values of the bubble volume rates.

FIG. 7 is a scatter diagram showing the radii of bubbles included in a resin foam of Comparative Example 3 and integrated values of the bubble volume rates.

FIG. 8 is a histogram showing the radii of the bubbles included in the resin foam of Example 1 and the bubble volume rates.

FIG. 9 is a histogram showing the radii of the bubbles included in the resin foam of Example 2 and the bubble volume rates.

FIG. 10 is a histogram showing the radii of the bubbles included in the resin foam of Example 3 and the bubble volume rates.

FIG. 11 is a histogram showing the radii of the bubbles included in the resin foam of Example 4 and the bubble volume rates.

FIG. 12 is a histogram showing the radii of the bubbles included in the resin foam of Comparative Example 1 and the bubble volume rates.

FIG. 13 is a histogram showing the radii of the bubbles included in the resin foam of Comparative Example 2 and the bubble volume rates.

FIG. 14 is a histogram showing the radii of the bubbles included in the resin foam of Comparative Example 3 and the bubble volume rates.

FIG. 15 is a graph showing the results of measurement of the elasticity moduli of the resin foams of Example 2 and Comparative Example 2.

FIG. 16 is a graph showing the results of measurement of the elasticity moduli of the resin foams of Example 2 and Comparative Example 2.

FIG. 17 is a three-dimensional images of the resin foams of Example 2 and Comparative Examples 2 and 3.

### DETAILED DESCRIPTION

An embodiment of the present disclosure will now be described in detail with reference to the drawings. The following description of a preferred embodiment is merely an example in nature, and is not intended to limit the scope, applications or use of the present disclosure.

### <Resin Foam>

A resin foam of the present disclosure has a bubble structure. The bubble structure includes an independent bubble structure and a continuous bubble structure, for example. In the independent bubble structure, bubbles exist independently from each other. In the continuous bubble structure, a bubble wall between adjacent bubbles has a communication hole causing the bubbles to communicate with each other. The resin foam of the present disclosure may have the independent bubble structure, the continuous bubble structure, or a mixture of the independent bubble structure and the continuous bubble structure. The bubble structure is preferably the continuous bubble structure.

The resin foam of the present disclosure includes: a first bubble group of bubbles having a radius r less than a predetermined value; and a second bubble group of bubbles having a radius r of the predetermined value or more. The predetermined value of the radius r that serves as the boundary between the first bubble group and the second bubble group ranges, but is not limited to, from 0.5 mm to 1.2 mm, that is, from 25% to 75%, preferably from 30% to 70%, and more preferably from 40% to 65% of the maximum bubble radius.

While the details will be described later, for the resin foam of the present disclosure, it is possible to obtain the number of bubbles included in the resin foam and the bubble radius r by capturing a three-dimensional transmission image and analyzing the three-dimensional structure. Using this number of bubbles and the bubble radius r, it is possible to obtain a histogram, for the resin foam of the present disclosure, which represents the volume rate of the bubbles for each predetermined radius range. The histogram shows the volume rate of the bubbles having the radius r, for each radius section rₙ, with respect to all the bubbles present in the analysis area of the resin foam excluding the minute bubbles which may be noise. The radius sections rₙ are 20 sections, i.e., radius sections r₁ to r₂₀, obtained by dividing the range of radii, from radius 0 mm to the maximus radius, of the bubbles in the analysis area of the resin foam, where n is an integer of 1 to 20. The volume rate of the bubbles having the radius r for each radius section rₙ is calculated in a range that is greater than the radius section rₙ₋₁ and less than or equal to the radius section rₙ. For example, if the range of radii from the radius 0 mm to the maximum bubble radius 1.0 mm is divided into 20 sections at equal intervals of 0.05 mm, the volume rate for the first radius section r₁ representing the smallest radius is calculated in the radius range of more than 0 mm and less than or equal to 0.05 mm, and the volume rate for the second radius section r₂ representing the second smallest radius is calculated in the radius range of more than 0.05 mm and less than or equal to 0.10 mm. This histogram is a multimodal histogram exhibiting a plurality of peaks of distribution, preferably a bimodal histogram. In this histogram, a plurality of peaks of the distribution appear with a predetermined value of the radius r serving as a boundary. In the case of a bimodal histogram, the first bubble group and the second bubble group appear as two peaks of the distribution with the predetermined value serving as the boundary. The predetermined value of the radius r at the valley between the two peaks serves as a boundary between the first bubble group and the second bubble group. For example, the predetermined value ranges from 0.5 mm to 1.2 mm, that is, from 25% to 75%, preferably from 30% to 70%, and more preferably from 40% to 65% of the maximum bubble radius.

While the details will be described later, for the resin foam of the present disclosure, it is possible to obtain the number of bubbles included in the resin foam and the bubble radius r by capturing a three-dimensional transmission image and analyzing the three-dimensional structure. Using this number of bubbles and the bubble radius r, it is possible to obtain a scatter diagram, for the resin foam of the present disclosure, which represents an integrated value of the volume rates of the bubbles for each predetermined radius range. The scatter diagram is obtained by plotting, on the radius sections rₙ, the integrated values of the bubble volume rates of all the bubbles present in the analysis area of the resin foam; the bubble volume rate is calculated by dividing the product of the number of bubbles having the radius r and the volume of the bubbles having the radius r by the volume of all the bubbles. The radius sections rₙ are 20 sections, i.e., radius sections r₁ to r₂₀, obtained by dividing at equal intervals the range of radii, from radius 0 mm to the maximus radius, of the bubbles in the analysis area of the resin foam, where n is an integer of 1 to 20. The volume rate of the bubbles having the radius r for each radius section rₙ is calculated in a range that is greater than the radius section rₙ₋₁ and less than or equal to the radius section rₙ. For example, if the range of radii from the radius 0 mm to the maximum bubble radius 1.0 mm is divided into 20 sections at equal intervals of 0.05 mm, the volume rates for the first radius section r₁ representing the smallest radius are integrated in the radius range of more than 0 mm and less than or equal to 0.05 mm, and the volume rates for the second radius section r₂ representing the second smallest radius are integrated in the radius range of more than 0.05 mm and less than or equal to 0.10 mm. Two approximate straight lines are obtained from this scatter diagram. The two approximate straight lines include: a first approximate straight line obtained from the plots of the first bubble group; and a second approximate straight line obtained from the plots of the second bubble group. The first approximate straight line and the second approximate straight line have different slopes. The predetermined value of the radius r at the boundary between the first approximate straight line and the second approximate straight line serves as a boundary between the first bubble group and the second bubble group. For example, the predetermined value ranges from 0.5 mm to 1.2 mm, that is, from 25% to 75%, preferably from 30% to 70%, and more preferably from 40% to 65% of the maximum bubble radius.

It is preferable that the sum of the bubble volume rates of the bubbles forming the second bubble group ranges from 10% to 80% of the whole bubble volume rate. It is preferable that the sum of the bubble volume rates of the bubbles forming the first bubble group is more than 20% and less than 90% of the whole bubble volume rate.

In the structural analysis described above, an image of the resin foam is captured by using an X-ray CT imaging apparatus; the image is converted into 3D data by using 3D data generation software; and the bubble structure is analyzed by using cell structure analysis software. It is thus possible to obtain the radius, volume rate, or other characteristics of the bubbles. An apparatus typically used for three-dimensional structural analysis and commercially available analysis software can be used. For example, an X-ray CT imaging apparatus (e.g., nano3DX) manufactured by Rigaku Holdings Corporation can be used to capture a three-dimensional stereoscopic image, and based on this stereoscopic image, calculation can be performed using 3D data generation software (e.g., ExFact (registered trademark), VR) and analysis software (e.g., ExFact (registered trademark), Analysis for Porous/Particles) manufactured by Nihon Visual Science, Inc.

In the resin foam of the present disclosure, the maximum radius of bubbles for which the structural analysis is performed is preferably less than 2000 μm in order to exclude voids caused by molding defects from the range of the structural analysis.

If used as a cushion material forming a seat of a passenger car, for example, the resin foam of the present disclosure preferably has a porosity of 90% or more.

The porosity is obtained by a known method. For example, an apparent volume Vd is obtained from a true volume Vc of a test piece and the outer size of the test piece, and the porosity is obtainable using the following equation: Porosity (%)=[(Vd−Vc)/Vd]×100. The porosity can also be measured using a porosity meter (e.g., PHI-X manufactured by Mecanum Inc.).

The resin foam of the present disclosure is typically obtained by foaming a resin composition. The resin contained in the resin composition is not particularly limited as long as it is moldable as a flexible foam used for a cushion material. Examples include an acrylic-based resin, a silicone resin, a urethane resin, an ester resin, a polyolefin-based resin, etc. One kind of resin may be used alone, or two more kinds may be used in combination.

Preferably, the resin foam of the present disclosure contains a cross-linkable polymer. More preferably, the cross-linkable polymer has a urethane bond.

An example of the resin foam of the present disclosure is a flexible polyurethane foam. The flexible polyurethane foam is obtained by foaming a resin composition containing a polyol, an isocyanate, a crosslinker, a catalyst, a foam stabilizer, a foaming agent, and other suitable components. Known raw materials used for the production of a flexible polyurethane foam can be employed as the raw materials constituting the resin composition. Other additives, such as a colorant, a stabilizer, a compatibilizer, a filler, and a flame retardant, may be added as needed.

Examples of the polyol include polyether polyol, polyester polyol, polymer polyol, etc. One kind of polyol may be used alone, or two more kinds may be used in combination.

Examples of the polyether polyol include polyethylene glycol, polypropylene glycol, polytetramethylene ether glycol, etc.

Examples of the polyester polyol include, but are not limited to, those obtained by a polycondensation reaction between a polycarboxylic acid, such as a phthalic acid, an isophthalic acid, a terephthalic acid, an oxalic acid, and an adipic acid, and polyol, such as ethylene glycol, propanediol, propylene glycol, and glycerin.

Examples of the polymer polyol include, but are not limited to, those obtained by polymerizing, for example, butadiene, acrylonitrile, or styrene in the presence of a catalyst, and those obtained by dispersing a polymer component, such as vinyl acetate and polyacrylonitrile, in polyether polyol.

Examples of the isocyanate include tolylene diisocyanate (TDI), diphenylmethane diisocyanate (MDI), modified MDI, naphthylene diisocyanate, biphenylene diisocyanate, diphenyl ether diisocyanate, etc. One kind of isocyanate may be used alone, or two more kinds may be used in combination.

Examples of the crosslinker include water, glycerin, 1,4-butanediol, diethylene glycol, ethanolamines, polyethylene polyamines, etc. One kind of the crosslinker may be used alone, or two more kinds may be used in combination.

Examples of the catalyst include amine catalysts, such as triethylenediamine (TEDA) and triethylamine, and metal catalysts, such as organic tin compounds, organic iron compounds, organic zinc compounds, and organic nickel compounds. One kind of the catalyst may be used alone, or two more kinds may be used in combination.

Examples of the foam stabilizer include a silicone-based compound, a surfactant, a phenol-based compound, etc. One kind of the foam stabilizer may be used alone, or two more kinds may be used in combination.

Examples of the foaming agent include water, carbon dioxide gas, ammonia, hydrofluorocarbon (HFC), hydrofluoroolefin (HFO), hydrochlorofluoroolefin (HCFO), etc. One kind of the foaming agent may be used alone, or two more kinds may be used in combination.

If the resin foam is a flexible polyurethane foam, the minimum spring constant at a compression rate of 10% or more is preferably 10 N/mm to 20 N/mm, more preferably 3 N/mm to 15 N/mm, and still more preferably 5 N/mm to 10 N/mm.

### EXAMPLES

### <Preparation of Resin Foam>

Next, a method for producing a resin foam which was actually conducted will be described.

As a blended polyol that is a main component, a polyol and additives (i.e., a crosslinker, a catalyst, a foam stabilizer, and a foaming agent) were mixed at the following ratios:
100 parts of polyol: obtained by adding polymer polyol to polyether polyol (with an average molecular weight of 5000 and three functional groups) as a main component;
3.5 parts of crosslinker: triethanolamine;
0.9 parts of catalyst: 33% triethylenediamine (67% dipropylene glycol), N,N-dimethylaminohexanol, bis(dimethylaminoethyl) ether;
0.6 parts of foam stabilizer: SZ-1302 and SZ-1342 manufactured by Dow (former Nippon Unicar Limited); and
3.5 parts of foaming agent: water

After adding an additive to the above blended polyol in each of Examples and Comparative Examples (except for Comparative Example 2), isocyanate was mixed in the blended polyol at a predetermined ratio, thereby preparing a resin composition to be a raw material of a resin foam. Immediately after the preparation, the resin composition was poured into a mold adjusted to 65° C., and the mold was closed with a lid. An aluminum mold in a size of 400 mm×400 mm×100 mm was used as the mold. The surface of the mold was coated with a wax-based release agent. Foaming was completed in the mold in about six minutes. A flexible polyurethane foam as the resin foam was taken out from the mold.

Next, the respective resin compositions of Examples and Comparative Examples will be described.

### Example 1

To the blended polyol described above, 1.0 part of a foam breaker was added, and a resin foam was obtained in accordance with the production method described above.

### Example 2

To the blended polyol described above, 2.0 parts of a foam breaker was added, and a resin foam was obtained in accordance with the production method described above.

### Example 3

To the blended polyol described above, 3.0 parts of a foam breaker was added, and a resin foam was obtained in accordance with the production method described above.

### Example 4

To the blended polyol described above, 5.0 parts of a foam breaker was added, and a resin foam was obtained in accordance with the production method described above.

### Comparative Example 1

To the blended polyol described above, 7.0 parts of a foam breaker was added, and a resin foam was obtained in accordance with the production method described above.

### Comparative Example 2

To the blended polyol described above, nothing was added, and a resin foam was obtained in accordance with the production method described above.

### Comparative Example 3

To the blended polyol described above, 0.5 parts of a foam stabilizer was added, and a resin foam was obtained in accordance with the production method described above.

Each of Examples 1 to 4 and Comparative Examples 1 to 3 described above was subjected to structural analysis, and the compressive elastic modulus and the porosity were measured and evaluated. Table 1 shows the results.

TABLE 1

| | | | | | | Comparative | Comparative | Comparative |
|---|---|---|---|---|---|---|---|---|
| | | Example 1 | Example 2 | Example 3 | Example 4 | Example 1 | Example 2 | Example 3 |
| Bubble | Distribution | Two Peaks | Two Peaks | Two Peaks | Two Peaks | Two Peaks | Two Peaks | One Peak |
| Structure | Shape of Histogram | | | | | | | |
| | Bubble Volume | 14.0 | 35.3 | 69.2 | 76.0 | 84.5 | 7.3 | — |
| | Rate of Second | | | | | | | |
| | Bubble Group [%] | | | | | | | |
| | Bubble Radius at Boundary | 0.57 | 0.65 | 0.74 | 1.17 | 1.32 | 0.50 | — |
| | between First Bubble | | | | | | | |
| | Group and Second | | | | | | | |
| | Bubble Group [mm] | | | | | | | |
| | (Predetermined Value) | | | | | | | |
| | Maximum Bubble | 1.13 | 1.19 | 1.49 | 1.72 | 2.21 | 0.77 | 0.89 |
| | Radius [mm] | | | | | | | |
| | Porosity | 0.94 | 0.94 | 0.94 | 0.94 | 0.94 | 0.94 | 0.94 |
| Elasticity | (1) Maximum Spring Constant | 29.4 | 19.6 | 25.0 | 28.4 | 29.2 | 31.9 | 33.6 |
| Modulus | at Compression Rate | | | | | | | |
| | Less than 10% [N/mm] | | | | | | | |
| | (2) Minimum Spring Constant | 8.8 | 8.4 | 7.8 | 8.1 | 6.6 | 7.4 | 6.7 |
| | at Compression Rate | | | | | | | |
| | of 10% or More [N/mm] | | | | | | | |
| | Ratio of (2)/(1) | 30% | 43% | 31% | 28% | 23% | 23% | 20% |
| | Evaluation | ∘ | ∘ | ∘ | ∘ | x | x | x |

### <Evaluation>

### —Structural Analysis—

An evaluation sample in a size of 10 mm×10 mm×10 mm was taken from a position 10 mm or more inward from the surface of a test block of the resin foam in a size of 400 mm×400 mm×100 mm produced in each of Examples 1 to 4 and Comparative Examples 1 to 3. Next, each of the evaluation samples was imaged using an X-ray CT imaging apparatus (i.e., nano3DX manufactured by Rigaku Holdings Corporation). The measurement area was 5424.3 μm×5424.3 μm×5424.3 μm. From the captured image, a resin part was extracted using 3D data generation software (ExFact (registered trademark), VR manufactured by Nihon Visual Science, Inc.) for conversion into three-dimensional data. Last, the three-dimensional data was analyzed for the bubble structure, using cell structure analysis software (i.e., ExFact (registered trademark), Analysis for Porous/Particles manufactured by Nihon Visual Science, Inc.). To obtain a radius of a bubble, the volume of the bubble was analyzed first, and the radius of the bubble was calculated from the volume, assuming that the bubble was spherical.

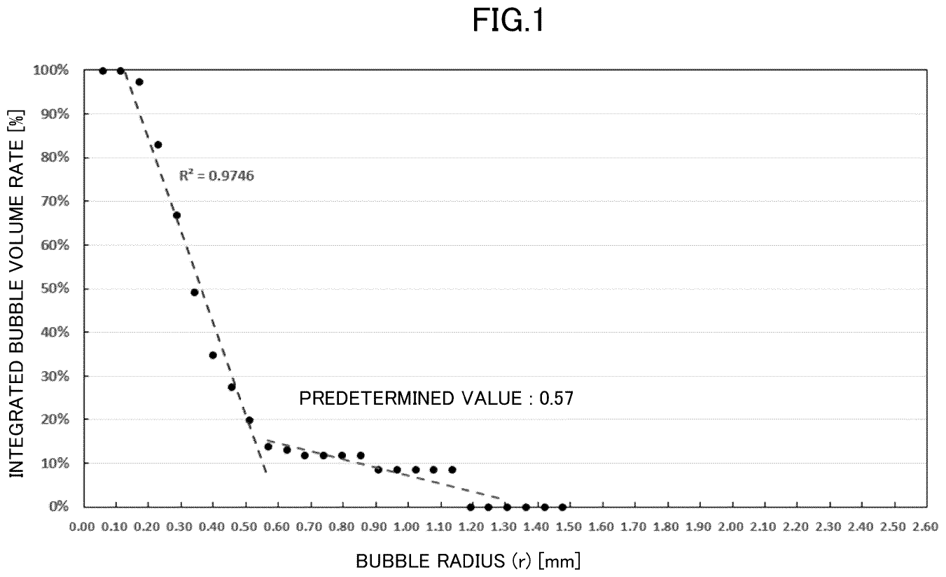

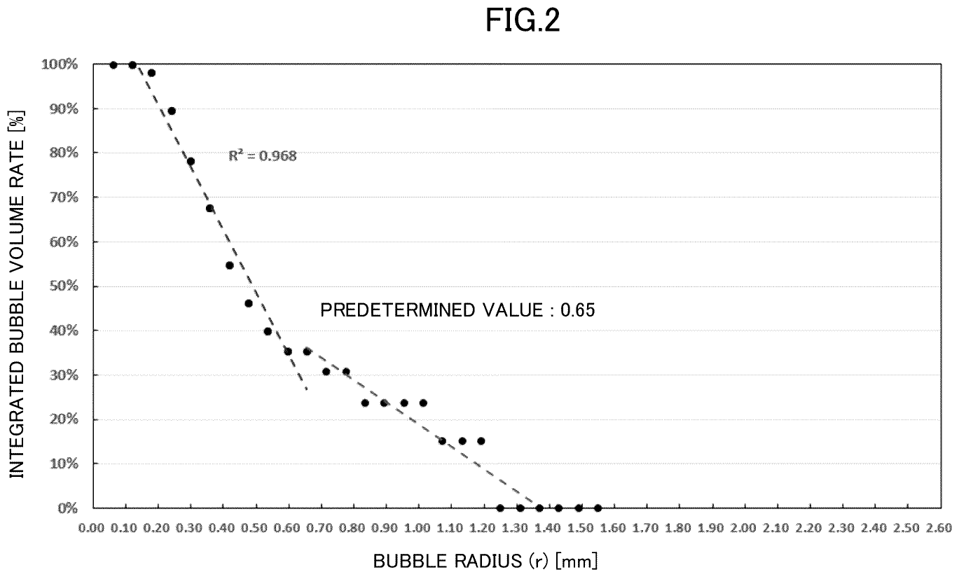

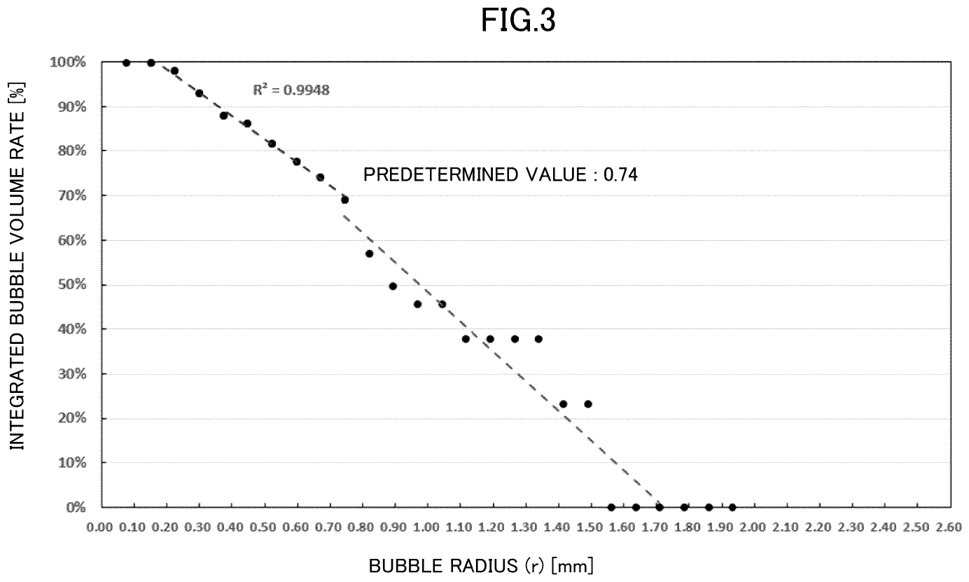

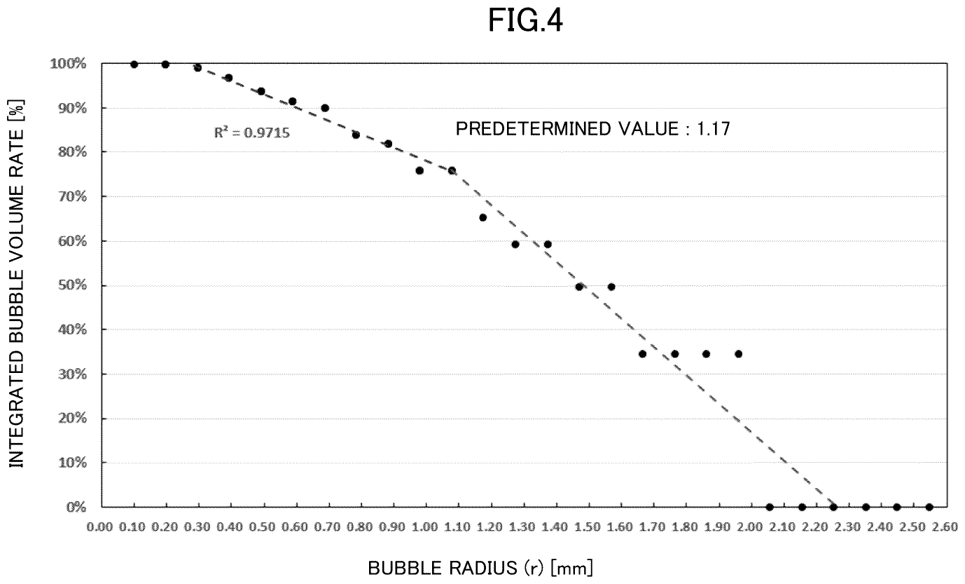

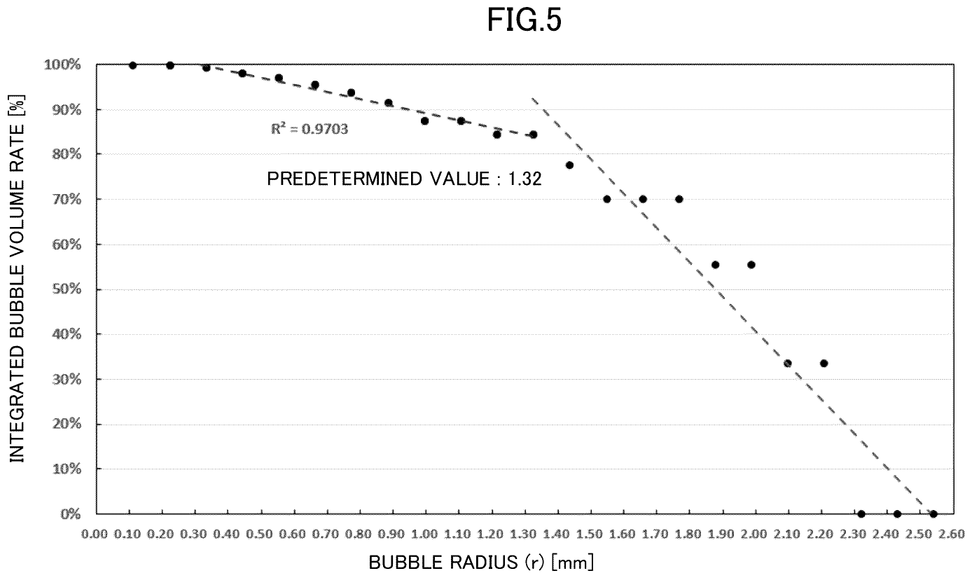

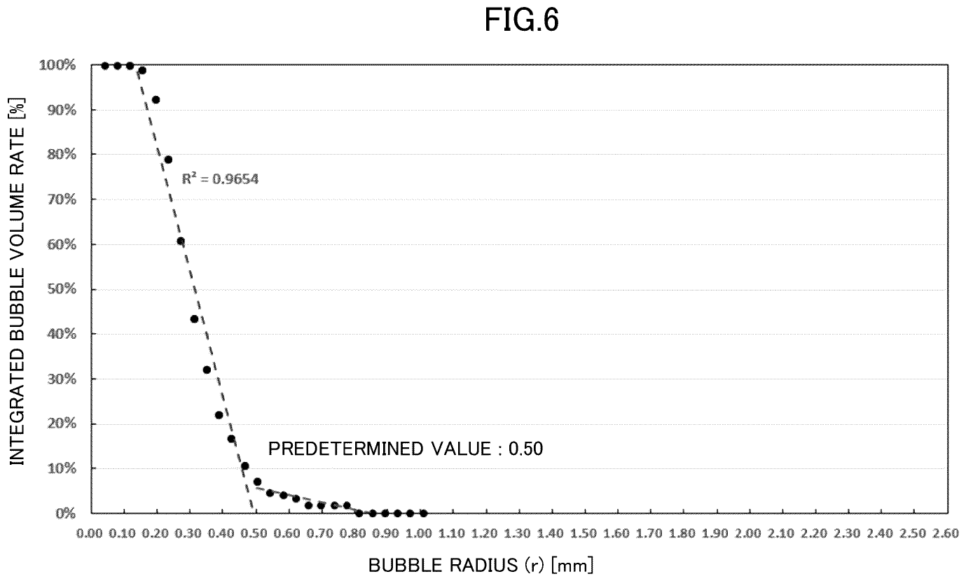

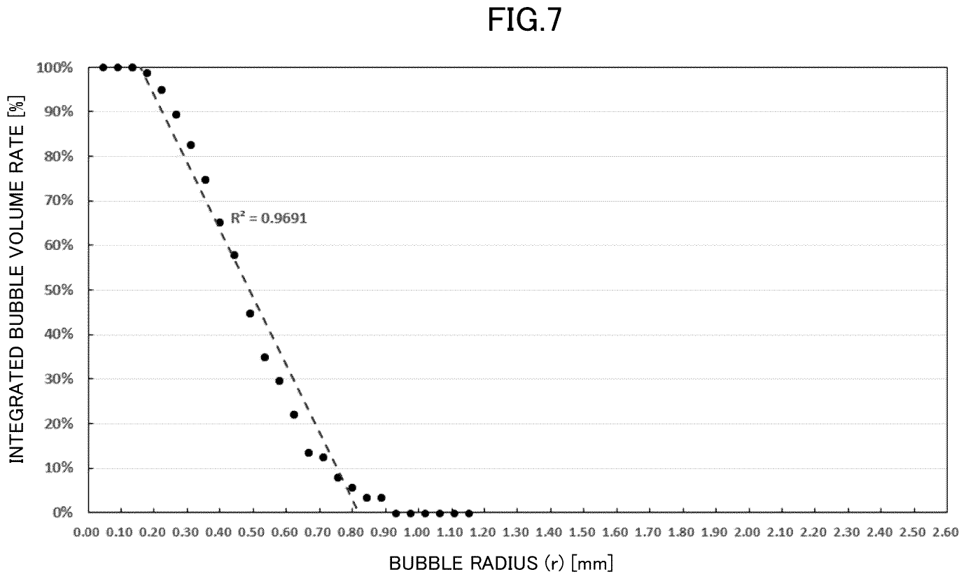

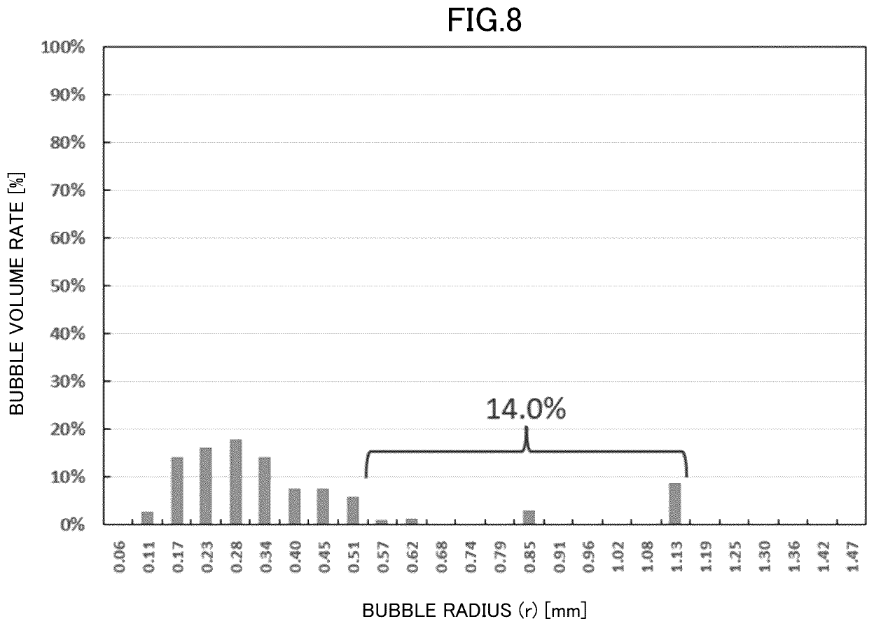

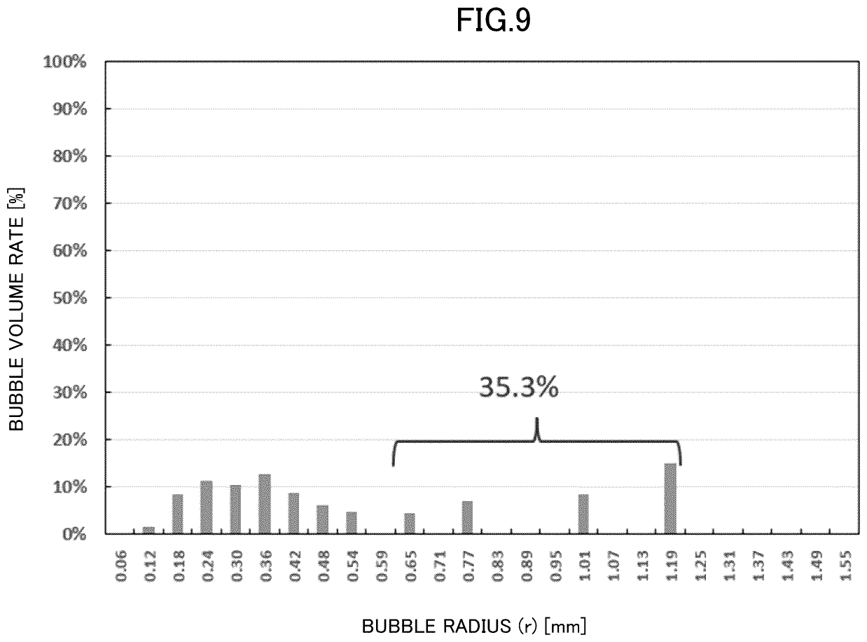

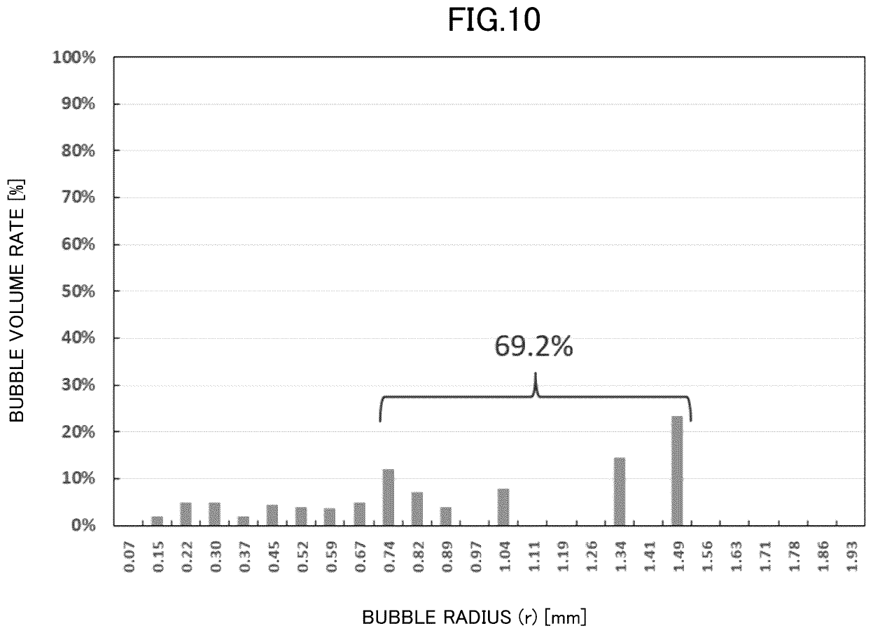

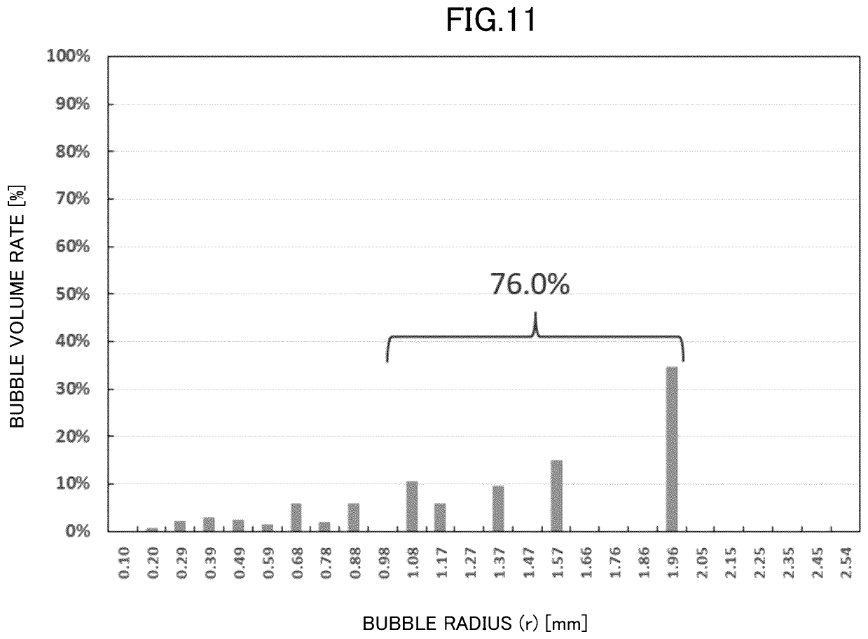

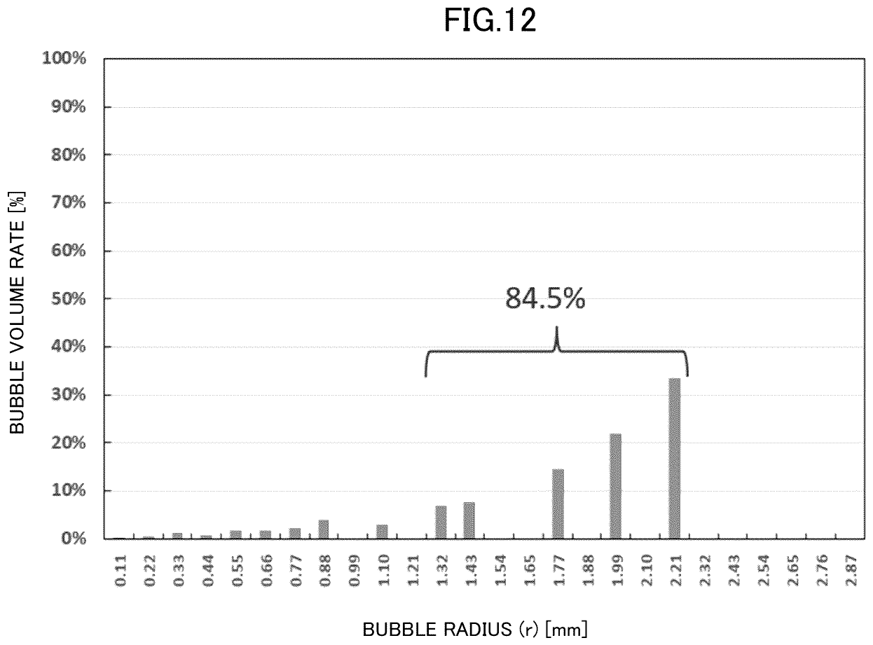

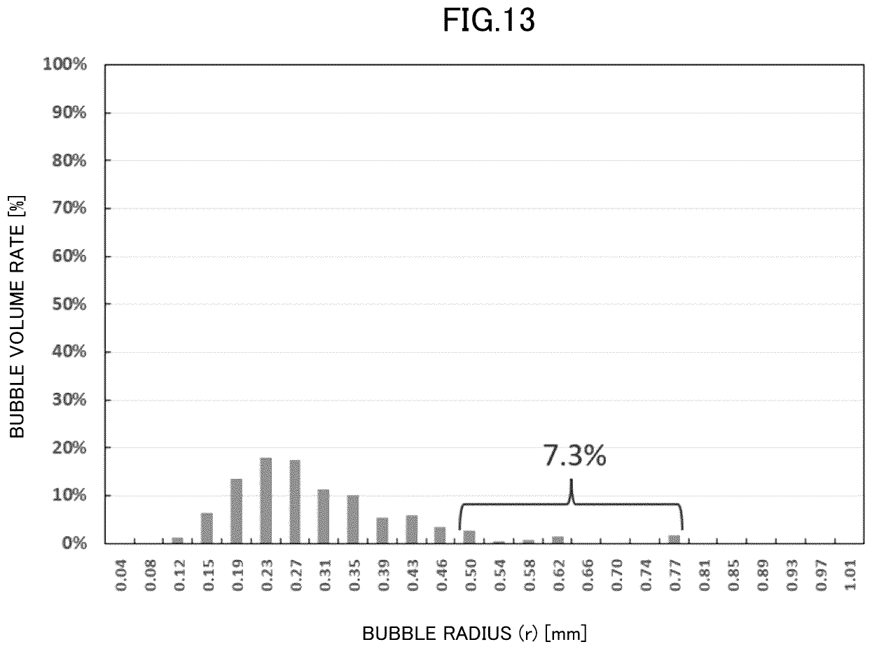

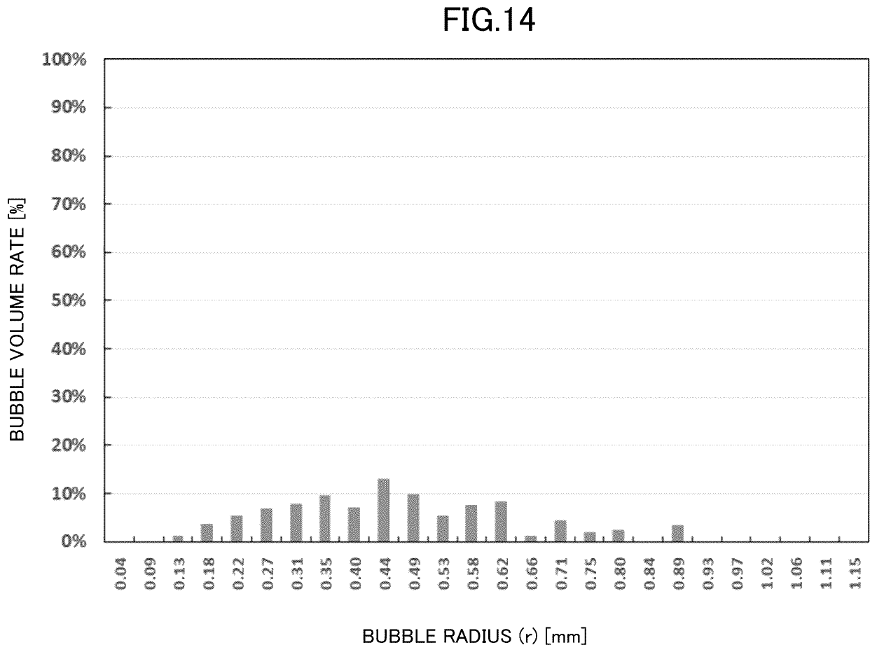

From the results of the structural analysis described above, bubbles having a bubble radius of 0.1 mm or more were extracted, and the radii of the bubbles included in the resin foam and the volume rates of the bubbles having the radii were calculated, thereby creating FIGS. 1 to 14. FIGS. 1 and 8 show a resin foam of Example 1. FIGS. 2 and 9 show a resin foam of Example 2. FIGS. 3 and 10 show a resin foam of Example 3. FIGS. 4 and 11 show a resin foam of Example 4. FIGS. 5 and 12 show a resin foam of Comparative Example 1. FIGS. 6 and 13 show a resin foam of Comparative Example 2. FIGS. 7 and 14 show a resin foam of Comparative Example 3.

FIGS. 1 to 7 are scatter diagrams. Each of these scatter diagrams is obtained in the following manner, using the number of bubbles and a bubble radius r, which are obtained by the structural analysis. First, the bubble radii are divided into predetermined radius ranges so that the volume rate of the bubbles for each of the predetermined radius ranges can be calculated. Specifically, a range of radii from the bubble radius of 0 mm to a maximum bubble radius of the bubbles included in the resin foam are divided into 20 radius sections r₁ to r₂₀ at equal intervals. Bubble volume rates are calculated by dividing the product of the number of bubbles having the radius r included in the range greater than a radius section rₙ₋₁ and less than or equal to a radius section rₙ, where n is an integer of 1 to 20, and the volume of the bubbles having the radius r by the volume of all the bubbles; and the thus obtained bubble volume rates are integrated sequentially from the side of the greater radius r to obtain an integrated bubble volume rate. This scatter diagram is obtained by plotting the integrated bubble volume rates calculated in this manner on the vertical axis and the radius sections rₙ on the horizontal axis.

In the scatter diagram (FIG. 1) and the histogram (FIG. 8) of Example 1, the range of radii from 0 mm to the maximum radius 1.13 mm is divided into 20 sections at equal intervals of 0.056 mm. The bubble volume rate and the integrated value thereof are obtained for each radius section. In the scatter diagram (FIG. 2) and the histogram (FIG. 9) of Example 2, the range of radii from 0 mm to the maximum radius 1.19 mm is divided into 20 sections at equal intervals of 0.059 mm. In the scatter diagram (FIG. 3) and the histogram (FIG. 10) of Example 3, the range of radii from 0 mm to the maximum radius 1.49 mm is divided into 20 sections at equal intervals of 0.074 mm. In the scatter diagram (FIG. 4) and the histogram (FIG. 11) of Example 4, the range of radii from 0 mm to the maximum radius 1.96 mm is divided into 20 sections at equal intervals of 0.074 mm. In the scatter diagram (FIG. 5) and the histogram (FIG. 12) of Comparative Example 1, the range of radii from 0 mm to the maximum radius 2.21 mm is divided into 20 sections at equal intervals of 0.11 mm. In the scatter diagram (FIG. 6) and the histogram (FIG. 13) of Comparative Example 2, the range of radii from 0 mm to the maximum radius 0.77 mm is divided into 20 sections at equal intervals of 0.039 mm. In the scatter diagram (FIG. 7) and the histogram (FIG. 14) of Comparative Example 3, the range of radii from 0 mm to the maximum radius 0.89 mm is divided into 20 sections at equal intervals of 0.044 mm.

In the scatter diagrams (FIGS. 1 to 6) of Examples 1 to 4 and Comparative Examples 1 and 2, attempts were made to obtain two approximate straight lines. First, the plot region of the first bubble group was considered so that the coefficient of determination of the first approximate straight line, obtained by the least squares method, from the point at which the integrated bubble volume rate was 100% be 0.965 or more (i.e., 0.97 or more by rounding to two decimal places). It was possible to obtain the maximum value rₙ of the radius section rₙ (i.e., the range of radii greater than rₙ₋₁ and equal to or less than rₙ) in the plot region of the first bubble group derived from the result of the consideration, as the radius which serves as the boundary, that is, the predetermined value of the bubble radius r.

For example, in FIG. 1, the plot region of the first bubble group obtained by the coefficient of determination described above was a region from the radius section r₁ to the radius section r₁₀. The radius 0.57 mm, which serves as the boundary in r₁₀ and is the maximum value in the region, was obtained as the predetermined value. Similarly, in FIG. 2, the plot region of the first bubble group was a region from the radius section r₁ to the radius section r₁₀, and the radius 0.65 mm, which serves as the boundary, was obtained as the predetermined value. In FIG. 3, the plot region of the first bubble group was a region from the radius section r₁ to the radius section r₁₀, and the radius 0.74 mm, which serves as the boundary, was obtained as the predetermined value. In FIG. 4, the plot region of the first bubble group was a region from the radius section r₁ to the radius section r₁₁, and the radius 1.17 mm, which serves as the boundary, was obtained as the predetermined value. In FIG. 5, the plot region of the first bubble group was a region from the radius section r₁ to the radius section r₁₂, and the radius 1.32 mm, which serves as the boundary, was obtained as the predetermined value. In FIG. 6, the plot region of the first bubble group was a region from the radius section r₁ to the radius section r₁₃, and the radius 0.50 mm, which serves as the boundary, was obtained as the predetermined value.

Next, a second approximate straight line formed from plots of the second bubble group was obtained by the least squares method in a region from the predetermined value of the bubble radius to a point at which the integrated bubble volume rate was 0%. In Comparative Example 3, one approximate straight line was obtained in a similar manner. The two approximate straight lines indicated by broken lines in FIGS. 1 to 6 include a first approximate straight line obtained from the plots of the first bubble group and a second approximate straight line obtained from the plots of the second bubble group. The first approximate straight line and the second approximate straight line have different slopes. In FIG. 7, only one approximate straight line was obtained.

FIGS. 8 to 14 are histograms, in which the vertical axis represents the volume rate of bubbles having the radius r and the horizontal axis represents the radius r. The histograms of Examples 1 to 4 and Comparative Examples 1 and 2 (FIGS. 8 to 13) were bimodal histograms exhibiting two peaks of distribution: the group of bubbles having a small radius and the group of bubbles having a large radius. The peak on the smaller radius side indicates the first bubble group, and the peak on the larger radius side indicates the second bubble group. The histogram of Comparative Example 3 (FIG. 14) was a unimodal histogram exhibiting only one peak of distribution.

The radius which serves as the boundary between the two approximate straight lines in FIGS. 1 to 6 is equal to the radius which serves as the boundary between the two peaks in FIGS. 8 to 13. The radius which serves as the boundary is the boundary between the first bubble group and the second bubble group. From the results of FIGS. 1 to 4 and FIGS. 8 to 11, in the resin foam of this embodiment, the radius which serves as the boundary between the first bubble group and the second bubble group ranges from 0.5 mm to 1.2 mm, that is, from 25% to 75%, preferably from 30% to 70%, and more preferably from 40% to 65% of the maximum bubble radius.

### —Porosity—

The porosity was measured using a porosity/density meter (PHI-X manufactured by Mecanum Inc. in Canada). The measurement method is an isochoric process at constant temperature, and the measurement environmental temperature is 15° C. to 30° C.

### —Compressive Elastic Modulus—

An evaluation sample (with a thickness of 100 mm) in a size of 10 mm×10 mm×10 mm was taken from a position 10 mm or more inward from the surface of a test block of the resin foam in a size of 400 mm×400 mm×100 mm produced in each of Examples 1 to 4 and Comparative Examples 1 to 3. A compression tester (Model-1840-TS, a load cell: MODEL 3200 (2KN), manufactured by Aikoh Engineering Co., Ltd.) was used as a test apparatus, and the test conditions were a compression rate of 200 mm/min and a load range of 0 N to 980 N. Before the test, each evaluation sample was kept still for 22 hours or more in the environment of 23° C. and a humidity of 50%. The evaluation samples were placed at intervals of about 20 mm on a flat plate having vent holes with a diameter of about 6 mm. Compression was started at a rate of 200 mm/min, and data on the height of compression (displacement) and the force of compression (compression load) were collected. After the compression load reached 980 N, the compression pressure was released, and the samples were released twice.

Based on the displacement and the compression load recorded in the compression test, changes in the compression load (N) and changes in the spring constant (N/mm) with respect to the displacement (mm) were plotted, thereby obtaining measurement results. Evaluations were made using B/A, where A represents the maximum spring constant at a compression rate of 10% or less, and B represents the minimum spring constant at a compression rate of 10% or more. It is conceivable that the smaller difference between the maximum spring constant and the minimum spring constant (the larger the ratio of B/A) means that both good sense of touch and good sense of support have been achieved. In Table 1 shown above, cases with the ratio B/A less than 25% were evaluated as “x”, assuming that not both good sense of touch and good sense of support had been achieved; and cases with the ratio B/A of 25% or more were evaluated as “◯”, assuming that both good sense of touch and good sense of support had been achieved.

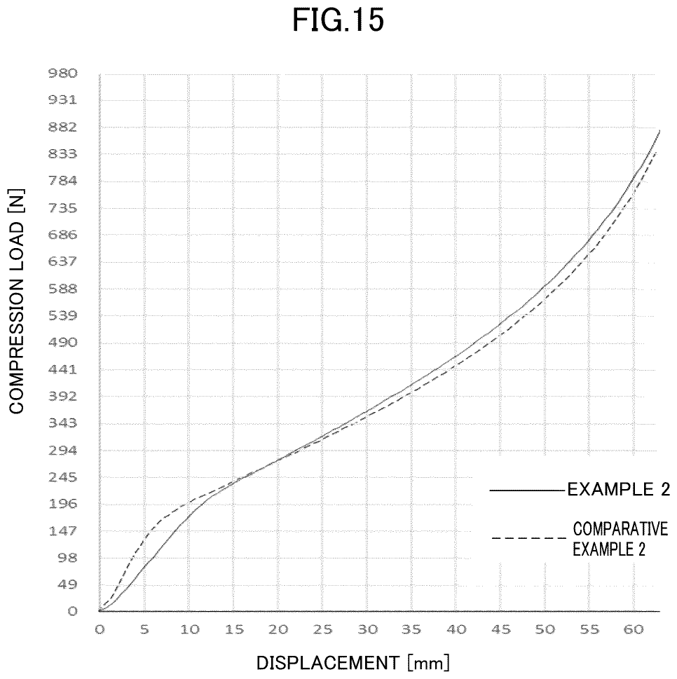

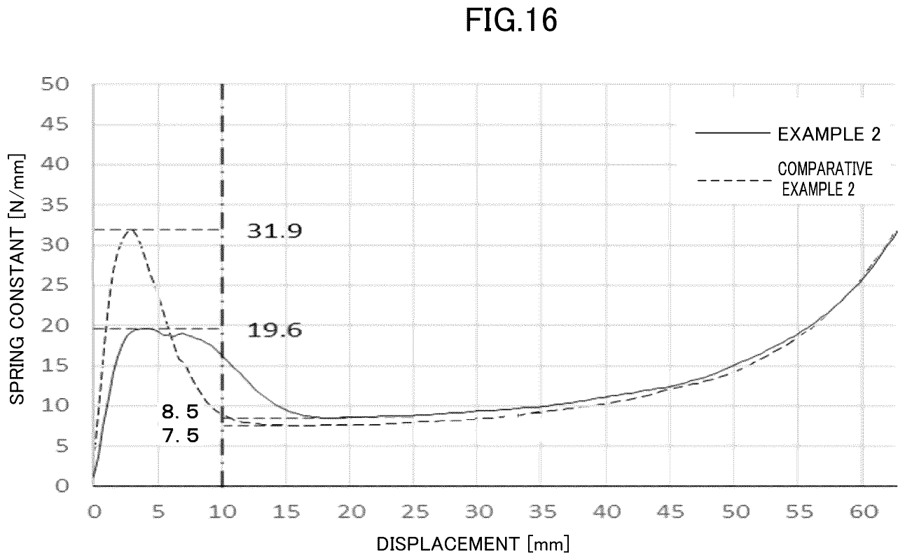

Examples of the results of measurement of the compressive elastic modulus are shown in FIGS. 15 and 16. FIG. 15 shows the results of measurement of the resin foams of Example 2 (solid line) and Comparative Example 2 (broken line), and is a graph showing a compression load with respect to displacement. FIG. 16 shows the results of measurement of the resin foams of Example 2 (solid line) and Comparative Example 2 (broken line), and is a graph showing a spring constant with respect to displacement. As shown in FIG. 16, in Example 2, the rise of the peak of the spring constant was slightly delayed at the initial stage where a load starts being applied (i.e., at the compression rate of 10% or less), resulting in a smaller maximum spring constant. This represents a good sense of touch. According to the resin foam of Example 2, bending of the resin foam occurs with a small displacement because the load is concentrated on the skeleton of the group of small bubbles between large bubbles; this is why the spring constant changes in the manner as shown in the figure. In Comparative Example 2, the rise of the peak of the spring constant was fast at the compression rate of 10% or less, resulting in a large maximum spring constant. This represents an inferior sense of touch to that of Example 2. Further, according to Example 2, the group of large bubbles can ensure the amount of stroke until a feel of touch to the bottom and improve the sense of support in the state of the load reaching the bottom. In Example 2, the minimum spring constant at a compression rate of 10% or more is a favorable value, which means that an excellent sense of support is obtainable. In Example 2, the difference between the maximum spring constant and the minimum spring constant was much smaller than that in Comparative Example 2, exhibiting that both the good sense of touch and the good sense of support were achieved.

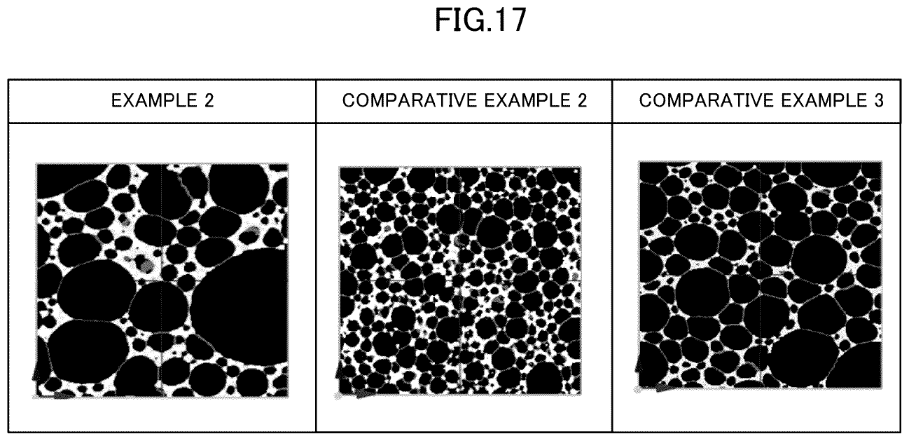

FIG. 17 shows three-dimensional images of the resin foams of Example 2 and Comparative Examples 2 and 3. In the image of Example 2, a group of small bubbles (a first bubble group) is observed between a group of large bubbles (a second bubble group); distances between the large bubbles are great; and between them, there are a large number of skeletons formed by the bubble walls of the group of small bubbles. Example 2 has a bubble structure that can achieve both the good sense of touch and the good sense of support. In the images of Comparative Examples 2 and 3, many bubbles in small to medium sizes are observed; there is no large difference in the size of the bubbles; and distances between the bubbles are small. It is difficult to achieve both the good sense of touch and the good sense of support in this structure.

### OTHER COMPARATIVE EXAMPLES

As other comparative examples, characteristics were compared to those of the resin foam of the present disclosure, using the data described in the above Patent Document 1. Specifically, the maximum spring constant A at a compression rate of 10% or less and the minimum spring constant B at a compression rate of 10% or more were obtained using the data of Examples 6 to 8 of Patent Document 1 described above (see FIG. 3 of Patent Document 1), and evaluations were made using B/A.

In Example 6 in Patent Document 1, B/A is 14%, where A is 32.5 N/mm and B is 4.7 N/mm.

In Example 7 in Patent Document 1, B/A is 14%, where A is 32.5 N/mm and B is 4.7 N/mm.

In Example 8 in Patent Document 1, B/A is 15%, where A is 32.5 N/mm and B is 5.0 N/mm.

In each case, B/A is smaller than 25% and seems to fail to achieve both the good sense of touch and the good sense of support.

The resin foam of the present disclosure is used for furniture, such as a sofa and a bed, and a seat of a passenger car, for example, and is significantly useful as a cushion material with excellent touch sensations that achieve both the good sense of touch and the good sense of support.

What is claimed is:

1. A resin foam comprising: a first bubble group of bubbles having a bubble radius less than a predetermined value; and a second bubble group of bubbles having a bubble radius of the predetermined value or more,
by using the number of bubbles included in the resin foam and a bubble radius r which are obtained by a structural analysis,
a range of radii from a bubble radius of 0 mm to a maximum bubble radius of the bubbles included in the resin foam being divided into 20 radius sections r₁ to r₂₀,
bubble volume rates being calculated by dividing a product of the number of bubbles having a radius r included in the range greater than a radius section rₙ₋₁ and less than or equal to a radius section rₙ, where n is an integer of 1 to 20, and a volume of the bubbles having the radius r by a volume of all the bubbles; the bubble volume rates being integrated for each radius section rₙ,
integrated values thus obtained being plotted on the respective radius sections rₙ, thereby obtaining a scatter diagram,
two approximate straight lines being obtained from the scatter diagram,
the two approximate straight lines including: a first approximate straight line obtained from plots of the first bubble group; and a second approximate straight line obtained from plots of the second bubble group, the first approximate straight line and the second approximate straight line having different slopes,
a sum of bubble volume rates of the bubbles forming the second bubble group ranging from 10% to 80% of a whole bubble volume rate.

2. The resin foam of claim 1, wherein
the predetermined value ranges from 25% to 75% of the maximum bubble radius.

3. The resin foam of claim 1, wherein
the maximum bubble radius in a structural analysis area is less than 2000 μm.

4. The resin foam of claim 1, further comprising:
a communication hole provided in a bubble wall between adjacent bubbles to cause the bubbles to communicate with each other.

5. The resin foam of claim 1, wherein
the resin foam is made of a resin composition containing a cross-linkable polymer.

6. The resin foam of claim 5, wherein
the cross-linkable polymer has a urethane bond.

7. The resin foam of claim 1, wherein
the resin foam is a flexible polyurethane foam.

8. The resin foam of claim 1, wherein
the resin foam has a porosity of 90% or more.

9. A seat using the resin foam of claim 1 as a cushion material.

10. A seat using the resin foam of claim 2 as a cushion material.

11. A seat using the resin foam of claim 3 as a cushion material.

12. A seat using the resin foam of claim 4 as a cushion material.

13. A seat using the resin foam of claim 5 as a cushion material.

14. A seat using the resin foam of claim 6 as a cushion material.

15. A seat using the resin foam of claim 7 as a cushion material.

16. A seat using the resin foam of claim 8 as a cushion material.
